(19) United States
(12) Patent Application Publication
(10) Pub. No.: US 2024/0377313 A1
(43) Pub. Date: Nov. 14, 2024

(54) COLORIMETRIC APPARATUS AND COLORIMETRIC METHOD

(71) Applicant: SEIKO EPSON CORPORATION, Tokyo (JP)

(72) Inventors: Masayoshi MIYAKAWA, SUWA-SHI (JP); Masahide MORIYAMA, MATSUMOTO-SHI (JP)

(21) Appl. No.: 18/661,287

(22) Filed: May 10, 2024

(30) Foreign Application Priority Data
May 12, 2023 (JP) 2023-079060

(51) Int. Cl. G01N 21/25

(52) U.S. Cl. CPC G01N 21/251; G01N 2201/021; G01N 2201/025

(57) ABSTRACT

A colorimetric apparatus includes a support base for supporting a colorimetric object, a colorimeter, a carriage movable in a first direction and a second direction while supporting the colorimeter, and a movement mechanism unit capable of moving the carriage in a third direction, wherein the carriage is movable in the second direction to a colorimetric position when measuring a color of a colorimetric patch and a moving position when the carriage moves in the first direction and the third direction, and is movable in the second direction to a first moving position and a second moving position longer in distance with respect to a support surface than the first moving position as the moving position.

The present application is based on, and claims priority from JP Application Serial Number 2023-079060, filed May 12, 2023, the disclosure of which is hereby incorporated by reference herein in its entirety.

### BACKGROUND

### 1. Technical Field

The present disclosure relates to a colorimetric apparatus and a colorimetric method.

### 2. Related Art

In the past, there have been used a variety of colorimetric apparatuses for measuring the color of a colorimetric object. For example, JP-A-2016-212001 discloses an automatic colorimetric apparatus to which a colorimeter for measuring the color of an object to be measured is attached. The automatic colorimetric apparatus in JP-A-2016-212001 is a colorimetric apparatus in which the colorimeter measures the color while moving with respect to the object to be measured.

In such a colorimetric apparatus in which the colorimeter measures the color while moving with respect to the colorimetric object as the automatic colorimetric apparatus in JP-A-2016-212001, there is a possibility that the colorimetric object and the colorimeter rub against each other, or a possibility that the colorimetric object and a carriage that supports the colorimeter rub against each other. This is because there is when unevenness originally exists in the colorimetric object itself, or when wrinkles or the like occur when the colorimetric object is placed on a support surface of a support base to thereby cause the unevenness, and when the unevenness of the colorimetric object is larger than an interval between the colorimetric object and the colorimeter or an interval between the colorimetric object and the carriage, the colorimeter and the carriage collide with such unevenness in some cases as the carriage moves.

### SUMMARY

In view of the problem described above, a colorimetric apparatus according to the present disclosure includes a support base configured to support a colorimetric object including a plurality of colorimetric patches with a support surface, a colorimeter configured to measure a color of the colorimetric object in a state of having contact with the colorimetric object, a carriage configured to support the colorimeter, and configured to move in a first direction along the support surface and a second direction opposed to the support surface, a movement mechanism unit configured to move the carriage on the support base in a third direction along the support surface and crossing the first direction, and a controller configured to control a position in the second direction of the carriage, wherein the carriage is configured to move in the second direction to a colorimetric position when measuring the color of the colorimetric patch and a moving position when the carriage moves in the first direction and the third direction under control by the controller, the carriage is configured to move in the second direction to a first moving position and a second moving position longer in distance with respect to the support surface than the first moving position as the moving position, and a colorimetric operation is executed setting the moving position to the first moving position or the second moving position.

Further, in view of the problem described above, a colorimetric method according to the present disclosure is a colorimetric method of a colorimetric apparatus including a support base configured to support a colorimetric object including a plurality of colorimetric patches with a support surface, a colorimeter configured to measure a color of the colorimetric object in a state of having contact with the colorimetric object, a carriage configured to support the colorimeter, and configured to move in a first direction along the support surface and a second direction opposed to the support surface, and a movement mechanism unit configured to move the carriage on the support base in a third direction along the support surface and crossing the first direction, wherein the carriage is configured to move in the second direction to a colorimetric position when measuring the color of the colorimetric patch and a moving position when the carriage moves in the first direction and the third direction, and the carriage is configured to move in the second direction to a first moving position and a second moving position longer in distance with respect to the support surface than the first moving position as the moving position, the method including executing a colorimetric operation setting the moving position to the first moving position or the second moving position in accordance with a state of the colorimetric object.

### BRIEF DESCRIPTION OF THE DRAWINGS

FIG. 1 is a schematic perspective view of a colorimeter which can be used in a colorimetric apparatus according to an embodiment of the present disclosure.

FIG. 2 is a perspective view of the colorimetric apparatus according to the embodiment of the present disclosure.

FIG. 3 is a perspective view showing an internal configuration of the colorimetric apparatus according to the embodiment of the present disclosure.

FIG. 4 is a bottom view showing the periphery of a carriage of the colorimetric apparatus according to the embodiment of the present disclosure, and is a view showing a state in which the colorimeter shown in FIG. 1 is housed.

FIG. 5 is a back view showing the periphery of the carriage of the colorimetric apparatus according to the embodiment of the present disclosure, and is a view showing an arrangement (a first moving position) when housing the colorimeter shown in FIG. 1 and performing scanning with the carriage.

FIG. 6 is a back view showing the periphery of the carriage of the colorimetric apparatus according to the embodiment of the present disclosure, and is a view showing an arrangement (a second moving position) when housing the colorimeter shown in FIG. 1 and performing scanning with the carriage.

FIG. 7 is a back view showing the periphery of the carriage of the colorimetric apparatus according to the embodiment of the present disclosure, and is a view showing an arrangement at a moment when the colorimeter shown in FIG. 1 is housed, and the carriage is moved downward from the state shown in FIG. 5 or FIG. 6 to make a colorimetric surface make contact with a colorimetric object.

FIG. 8 is a back view showing the periphery of the carriage of the colorimetric apparatus according to the embodiment of the present disclosure, and is a view showing an arrangement when the colorimeter shown in FIG. 1 is housed and the carriage is further moved downward from the state shown in FIG. 7 to perform colorimetry of the colorimetric object.

FIG. 9 is a back view showing the periphery of the carriage of the colorimetric apparatus according to the embodiment of the present disclosure, and is a view showing an arrangement in which the colorimeter shown in FIG. 1 is housed and the carriage is further moved downward from the state shown in FIG. 8 and the bottom surface of the carriage makes contact with the colorimetric object.

FIG. 10 is a back view showing the periphery of the carriage of the colorimetric apparatus according to the embodiment of the present disclosure, and is a view showing an arrangement in a state in which the colorimeter shown in FIG. 1 is housed and the carriage is moved to a home position.

FIG. 11 is a block diagram illustrating an electrical configuration of the colorimetric apparatus according to the embodiment of the present disclosure.

FIG. 12 is a flowchart showing an example of a control method to be performed using the colorimetric apparatus according to the embodiment of the present disclosure, and showing a flow when determining a setting position of the carriage in a height direction.

FIG. 13 is a graph showing a color difference of a colorimetric value when the carriage is gradually raised from a colorimetric value measured in a state in which the carriage has contact with the colorimetric object.

FIG. 14 is a flowchart showing an example of the control method to be performed using the colorimetric apparatus according to the embodiment of the present disclosure, and showing a flow of measuring the thickness in the height direction of the colorimetric object to be performed before executing the flow of the flowchart in FIG. 12.

FIG. 15 is a flowchart showing an example of a control method to be performed using the colorimetric apparatus according to the embodiment of the present disclosure, and showing a flow when changing the colorimeter to be used.

FIG. 16 is a flowchart of a colorimetric method in Practical Example 1 to be performed using the colorimetric apparatus according to the embodiment of the present disclosure.

FIG. 17 is a flowchart of a colorimetric method in Practical Example 2 to be performed using the colorimetric apparatus according to the embodiment of the present disclosure.

### DESCRIPTION OF EMBODIMENTS

The present disclosure will schematically be described below.

A colorimetric apparatus according to a first aspect includes a support base configured to support a colorimetric object including a plurality of colorimetric patches with a support surface, a colorimeter configured to measure a color of the colorimetric object in a state of having contact with the colorimetric object, a carriage configured to support the colorimeter, and configured to move in a first direction along the support surface and a second direction opposed to the support surface, a movement mechanism unit configured to move the carriage on the support base in a third direction along the support surface and crossing the first direction, and a controller configured to control a position in the second direction of the carriage, wherein the carriage is configured to move in the second direction to a colorimetric position when measuring the color of the colorimetric patch and a moving position when the carriage moves in the first direction and the third direction under control by the controller, the carriage is configured to move in the second direction to a first moving position and a second moving position longer in distance with respect to the support surface than the first moving position as the moving position, and a colorimetric operation is executed setting the moving position to the first moving position or the second moving position.

According to the present aspect, the carriage is movable in the second direction to the first moving position and the second moving position longer in distance with respect to the support surface than the first moving position as the moving position when moving in the first direction and the third direction. Therefore, when the colorimetric object has unevenness, and there is a possibility that the colorimetric object and the colorimeter rub against each other or a possibility that the colorimetric object and the carriage rub against each other, and so on, by setting the moving position to the second moving position, it becomes possible to prevent the colorimetric object and the colorimeter from rubbing against each other, and the colorimetric object and the carriage from rubbing against each other. Therefore, it is possible to prevent the colorimetric object from being damaged, the colorimeter and the carriage from being damaged, and so on.

Then, a colorimetric apparatus according to a second aspect is an aspect according to the first aspect, and further includes a storage unit configured to store an offset amount related to the moving position, wherein the second moving position is a position obtained by adding the offset amount to the first moving position in a separating direction of getting away from the support surface.

According to the present aspect, the second moving position is the position obtained by adding the offset amount stored in the storage unit to the first moving position in the separating direction of getting away from the support surface. Therefore, it is possible for the user to omit the trouble of setting the offset amount.

Then, a colorimetric apparatus according to a third aspect is an aspect according to the first aspect, wherein the controller is configured to receive input of an offset amount related to the moving position, and the second moving position is a position obtained by adding the offset amount to the first moving position in a separating direction of getting away from the support surface.

According to the present aspect, it is possible for the controller to receive the input of the offset amount related to the moving position, and the second moving position is the position obtained by adding the offset amount to the first moving position in the separating direction of getting away from the support surface. Therefore, it is possible for the user to suitably set the offset amount in accordance with the level of the unevenness of the colorimetric object and so on.

Then, a colorimetric apparatus according to a fourth aspect is an aspect according to one of the second and third aspects, wherein when the position obtained by adding the offset amount to the first moving position in the separating direction exceeds a limit position of a movable range in the separating direction of the carriage, the controller sets the limit position as the second moving position.

According to the present aspect, when the position obtained by adding the offset amount to the first moving position in the separating direction exceeds the limit position of the movable range in the separating direction of the carriage, the controller sets the limit position as the second moving position. Therefore, it is possible to prevent that the moving position is set beyond the limit position of the movable range in the separating direction of the carriage to cause a problem in the apparatus.

Then, a colorimetric apparatus according to a fifth aspect is an aspect according to any one of the first through fourth aspects, wherein the controller is configured to receive an instruction to change the moving position from the first moving position to the second moving position, and is configured to change the moving position from the first moving position to the second moving position in response to receiving the instruction.

According to the present aspect, the controller is capable of receiving the instruction to change the moving position from the first moving position to the second moving position, and changes the moving position from the first moving position to the second moving position in response to receiving the instruction. Therefore, when the user conceives that there is a possibility that the colorimetric object and the colorimeter rub against each other or a possibility that the colorimetric object and the carriage rub against each other, it is possible for the user to change the moving position from the first moving position to the second moving position in accordance with the user's intension.

Then, a colorimetric apparatus according to a sixth aspect is an aspect according to the fifth aspect, wherein the colorimetric object is provided with a detection target portion to be used to detect a position when the colorimetric object is supported by the support surface, and the carriage includes a detection unit configured to detect the detection target portion, and is configured to set the moving position when detecting the detection target portion to the second moving position in response to receiving the instruction under control by the controller.

According to the present aspect, the moving position when detecting the detection target portion is set to the second moving position in response to receiving the instruction to change the moving position from the first moving position to the second moving position. Therefore, it is possible to prevent the colorimetric object from being damaged, the colorimeter and the carriage from being damaged, and so on when detecting the detection target portion.

Then, a colorimetric apparatus according to a seventh aspect is an aspect according to the fifth aspect, and further includes a first motor as a drive source of movement in the first direction of the carriage, and a second motor as a drive source of movement in the third direction of the carriage, wherein at least one of exceedance of a load of the first motor over a first load and exceedance of a load of the second motor over a second load is announced.

According to the present aspect, there is adopted a configuration in which at least one of the exceedance of the load of the first motor over the first load and the exceedance of the load of the second motor over the second load is announced. Here, when the colorimetric object and one of the colorimeter and the carriage rub against each other, the load of the first motor or the second motor increases. Therefore, when there is a high possibility that the colorimetric object and one of the colorimeter and the carriage rub against each other, it is possible for the user to figure out this fact, and to thereafter prevent such rubbing by changing the moving position from the first moving position to the second moving position.

Then, a colorimetric apparatus according to an eighth aspect is an aspect according to the fifth aspect, and further includes a first motor as a drive source of movement in the first direction of the carriage, a first encoder configured to measure a rotation amount by the first motor, a second motor as a drive source of movement in the third direction of the carriage, and a second encoder configured to measure a rotation amount by the second motor, wherein at least one of a change in variation of the rotation amount of the first encoder to a level equal to or less than a first threshold value and a change in variation of the rotation amount of the second encoder to a level equal to or less than a second threshold value is announced.

According to the present aspect, there is adopted a configuration in which at least one of the change in variation of the rotation amount of the first encoder to the level equal to or less than the first threshold value and the change in variation of the rotation amount of the second encoder to the level equal to or less than the second threshold value is announced. Here, when the colorimetric object and one of the colorimeter and the carriage rub against each other, the variation of the rotation amount detected by the encoder for measuring the rotation amount of the motor decreases. Therefore, when there is a high possibility that the colorimetric object and one of the colorimeter and the carriage rub against each other, it is possible for the user to figure out this fact, and to thereafter prevent such rubbing by changing the moving position from the first moving position to the second moving position.

Then, a colorimetric apparatus according to a ninth aspect is an aspect according to the fifth aspect, and further includes a first motor as a drive source of movement in the first direction of the carriage, a first encoder configured to measure a rotation amount by the first motor, a second motor as a drive source of movement in the third direction of the carriage, and a second encoder configured to measure a rotation amount by the second motor, wherein at least one of a change in moving speed of the carriage based on the rotation amount of the first encoder to a level equal to or less than a third threshold value and a change in moving speed of the carriage based on the rotation amount of the second encoder to a level equal to or less than a fourth threshold value is announced.

According to the present aspect, there is adopted a configuration in which at least one of the change in moving speed of the carriage based on the rotation amount of the first encoder to the level equal to or less than the third threshold value and the change in moving speed of the carriage based on the rotation amount of the second encoder to the level equal to or less than the fourth threshold value is announced. Here, when the colorimetric object and one of the colorimeter and the carriage rub against each other, the moving speed of the carriage based on the rotation amount of the motor decreases. Therefore, when there is a high possibility that the colorimetric object and one of the colorimeter and the carriage rub against each other, it is possible for the user to figure out this fact, and to thereafter prevent such rubbing by changing the moving position from the first moving position to the second moving position.

Then, a colorimetric apparatus according to a tenth aspect is an aspect according to any one of the first through fourth aspects, wherein the controller is configured to accept movement information related to at least one of the first direction and the third direction of the carriage, and is configured to determine whether to set the moving position to the first moving position or to set the moving position to the second moving position based on the movement information.

According to the present aspect, the controller is configured to accept the movement information related to at least one of the first direction and the third direction of the carriage, and is configured to determine whether to set the moving position to the first moving position or to set the moving position to the second moving position based on the movement information. Therefore, when there is a possibility that the colorimetric object and one of the colorimeter and the carriage rub against each other, it is possible to automatically change the moving position from the first moving position to the second moving position.

Then, a colorimetric apparatus according to an eleventh aspect is an aspect according to the tenth aspect, and further includes a first motor as a drive source of movement in the first direction of the carriage, and a second motor as a drive source of movement in the third direction of the carriage, wherein the controller is configured to determine the second moving position as the moving position when at least one of exceedance of a load of the first motor as the movement information over a first load and exceedance of a load of the second motor as the movement information over a second load is true.

According to the present aspect, when at least one of the exceedance of the load of the first motor as the movement information over the first load and the exceedance of the load of the second motor as the movement information over the second load is true, the controller determines the second moving position as the moving position. Since the load of the first motor or the second motor increases when the colorimetric object and one of the colorimeter and the carriage rub against each other, when there is a high possibility that the colorimetric object and one of the colorimeter and the carriage rub against each other, it is possible to automatically change the moving position from the first moving position to the second moving position, and it is possible to thereafter prevent such rubbing.

Then, a colorimetric apparatus according to a twelfth aspect is an aspect according to the tenth aspect, and further includes a first motor as a drive source of movement in the first direction of the carriage, a first encoder configured to measure a rotation amount by the first motor, a second motor as a drive source of movement in the third direction of the carriage, and a second encoder configured to measure a rotation amount by the second motor, wherein the controller is configured to determine the second moving position as the moving position when at least one of a change in variation of the rotation amount of the first encoder as the movement information to a level equal to or less than a first threshold value and a change in variation of the rotation amount of the second encoder as the movement information to a level equal to or less than a second threshold value is true.

According to the present aspect, when at least one of the change in variation of the rotation amount of the first encoder as the movement information to the level equal to or less than the first threshold value and the change in variation of the rotation amount of the second encoder as the movement information to the level equal to or less than the second threshold value is true, the controller determines the second moving position as the moving position. Since the variation of the rotation amount to be detected by the encoder for measuring the rotation amount of the motor decreases when the colorimetric object and one of the colorimeter and the carriage rub against each other, when there is a high possibility that the colorimetric object and one of the colorimeter and the carriage rub against each other, it is possible to automatically change the moving position from the first moving position to the second moving position, and it is possible to thereafter prevent such rubbing.

Then, a colorimetric apparatus according to a thirteenth aspect is an aspect according to the tenth aspect, and further includes a first motor as a drive source of movement in the first direction of the carriage, a first encoder configured to measure a rotation amount by the first motor, a second motor as a drive source of movement in the third direction of the carriage, and a second encoder configured to measure a rotation amount by the second motor, wherein the controller is configured to determine the second moving position as the moving position when at least one of a change in moving speed of the carriage based on the rotation amount of the first encoder as the movement information to a level equal to or less than a third threshold value and a change in moving speed of the carriage based on the rotation amount of the second encoder as the movement information to a level equal to or less than a fourth threshold value is true.

According to the present aspect, when at least one of the change in moving speed of the carriage based on the rotation amount of the first encoder as the movement information to the level equal to or less than the third threshold value and the change in moving speed of the carriage based on the rotation amount of the second encoder as the movement information to the level equal to or less than the fourth threshold value is true, the controller determines the second moving position as the moving position. Since the moving speed of the carriage based on the rotation amount of the motor decreases when the colorimetric object and one of the colorimeter and the carriage rub against each other, when there is a high possibility that the colorimetric object and one of the colorimeter and the carriage rub against each other, it is possible to automatically change the moving position from the first moving position to the second moving position, and it is possible to thereafter prevent such rubbing.

Then, a colorimetric method according to a fourteenth aspect is a colorimetric method of a colorimetric apparatus including a support base configured to support a colorimetric object including a plurality of colorimetric patches with a support surface, a colorimeter configured to measure a color of the colorimetric object in a state of having contact with the colorimetric object, a carriage configured to support the colorimeter, and configured to move in a first direction along the support surface and a second direction opposed to the support surface, and a movement mechanism unit configured to move the carriage on the support base in a third direction along the support surface and crossing the first direction, wherein the carriage is configured to move in the second direction to a colorimetric position when measuring the color of the colorimetric patch and a moving position when the carriage moves in the first direction and the third direction, and the carriage is configured to move in the second direction to a first moving position and a second moving position longer in distance with respect to the support surface than the first moving position as the moving position, the method including executing a colorimetric operation setting the moving position to the first moving position or the second moving position in accordance with a state of the colorimetric object.

According to the present aspect, the carriage is movable in the second direction to the first moving position and the second moving position longer in distance with respect to the support surface than the first moving position as the moving position when moving in the first direction and the third direction. Therefore, when the colorimetric object has unevenness, and there is a possibility that the colorimetric object and the colorimeter rub against each other or a possibility that the colorimetric object and the carriage rub against each other, and so on, by setting the moving position to the second moving position, it becomes possible to prevent the colorimetric object and the colorimeter from rubbing against each other, and the colorimetric object and the carriage from rubbing against each other. Therefore, it is possible to prevent the colorimetric object from being damaged, the colorimeter and the carriage from being damaged, and so on.

The present disclosure will specifically be described below.

It should be noted that an X-Y-Z coordinate system shown in the drawings is an orthogonal coordinate system, wherein an X-Y plane corresponds to a horizontal plane and an X-Z plane and a Y-Z plane correspond to vertical planes. Here, a Z-axis direction is a vertical direction, that is, a height direction, a +Z direction is a vertically upward direction, and a −Z direction is a vertically downward direction. Further, an X-axis direction is a horizontal direction perpendicular to the Z-axis direction which is the vertical direction. Further, a Y-axis direction is the horizontal direction and is a direction perpendicular to both of the X-axis direction and the Z-axis direction. Here, the Y-axis direction corresponds to a first direction described later, the Z-axis direction corresponds to a second direction described later, and the X-axis direction corresponds to a third direction described later. It should be noted that, in the following description, a +Y direction side of a colorimetric apparatus 1 is set as a back direction side, a −Y direction side of the colorimetric apparatus 1 is set as a front direction side, a +X direction side of the colorimetric apparatus 1 is set as a right direction side, and a −X direction side of the colorimetric apparatus 1 is set as a left direction side.

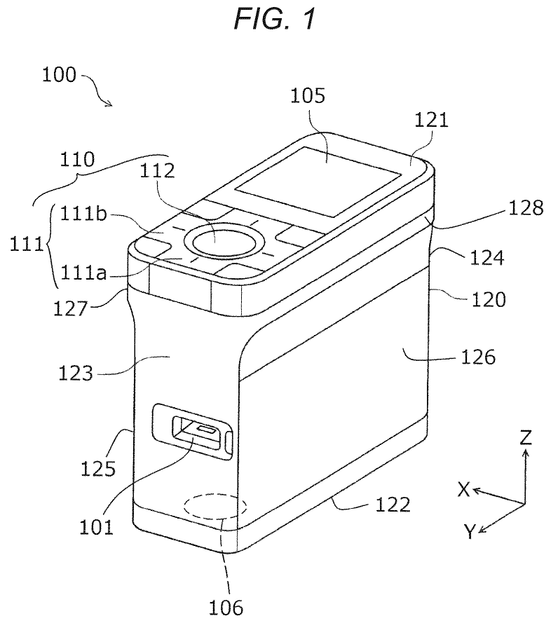

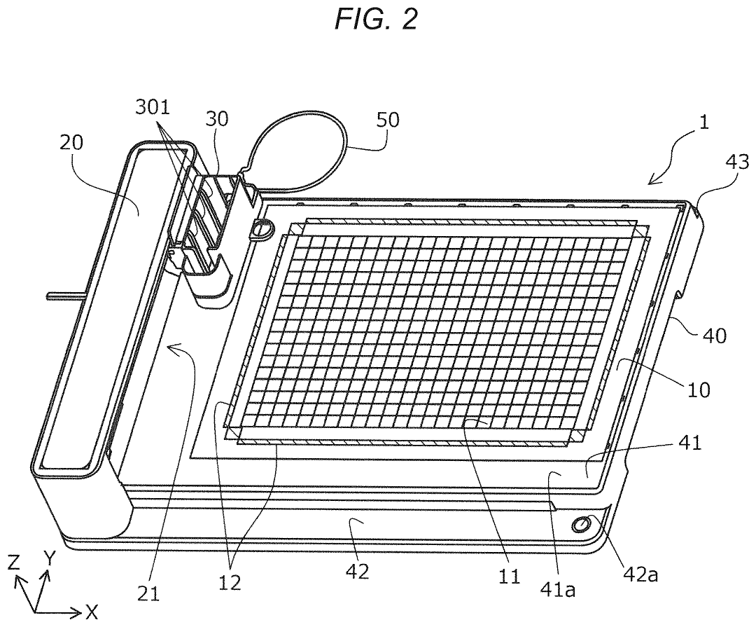

First, an embodiment of a colorimeter 100 which can be used in the colorimetric apparatus 1 according to the embodiment of the present disclosure will be described with reference to FIG. 1. The colorimeter 100 according to the present embodiment is an optical device that includes a colorimetric opening 106, emits light in the −Z direction from the colorimetric opening 106, and then receives the light reflected by a color chart 10, which is a colorimetric object illustrated in FIG. 2, to thereby perform colorimetry. In other words, an optical axis direction is the Z-axis direction and the position of the optical axis corresponds to the position of the colorimetric opening 106.

The colorimeter 100 in the present embodiment includes a housing 120 having an upper surface 121, which is a surface at the +Z direction side, a colorimetric surface 122, which is a bottom surface at the −Z direction side and is provided with the colorimetric opening 106, a back surface 123, which is a surface at the +Y direction side, a front surface 124, which is a surface at the −Y direction side, a right side surface 125, which is a surface at the +X direction side, and a left side surface 126, which is a surface at the −X direction side.

On the upper surface 121, an operation unit 110 and a screen unit 105 are disposed along the Y-axis direction. Specifically, the operation unit 110 is disposed at the +Y direction side of the upper surface 121, and the screen unit 105 is disposed at the −Y direction side of the upper surface 121. The operation unit 110 includes a plus-shaped button 111 formed of a bar shape 111a extending along the Y-axis direction and a bar shape 1l1b extending along the X-axis direction, and a determination button 112 disposed at the center of the plus-shaped button 111. For example, it is possible for the user to determine desired one of a plurality of menus displayed on the screen unit 105 by pressing the plus-shaped button 111 to move a menu to be activated forward, backward, leftward, and rightward and then pressing the determination button 112.

A terminal 101 to which a USB cable 50 illustrated in FIG. 2 and the like can be connected is formed at the back surface 123. Further, the colorimeter 100 in the present embodiment is provided with a convex portion 127 and a convex portion 128 which are convex toward the outer side when viewed in the Y-axis direction. Specifically, the convex portion 127 is provided in a region further at the +Z direction side than the center in the Z-axis direction on the right side surface 125 and the convex portion 128 is provided in a region at the +Z direction side of the center in the Z-axis direction on the left side surface 126.

Then, a detailed configuration of the colorimetric apparatus 1 according to the embodiment of the present disclosure will be described with reference to FIG. 2 through FIG. 9. FIG. 2 shows a configuration of the colorimetric apparatus 1 according to the present embodiment. The colorimetric apparatus 1 is provided with a main body unit 40 including a support base 41 extended in the X-axis direction and the Y-axis direction, and is further provided with a gantry 20 extending in the Y-axis direction so as to cover a part of a support surface 41a of the support base 41 from the +Z direction side.

A carriage 30 capable of housing the colorimeter 100 is attached to the gantry 20. The gantry 20 is a movement mechanism unit that is movable in the X-axis direction with respect to the support base 41, and the carriage 30 is movable along the Y-axis direction with respect to the gantry 20. These movements are also called scanning. Here, the carriage 30 is capable of moving along the Y-axis direction with respect to the gantry 20, and is also capable of moving along the Z-axis direction with respect to the gantry 20. One end of the USB cable 50 is coupled to the gantry 20, and at the same time, the other end of the USB cable 50 is coupled to the colorimeter 100 housed in the carriage 30.

A color chart 10, which is an example of an object to be measured, can be placed on the support surface 41a of the support base 41, and the color chart 10 is configured with, for example, a plurality of color patches 11 and a black frame 12. The color chart 10 is fixed to the support base 41 by, for example, attaching an adhesive tape around the color chart 10, and corresponds to automatic colorimetry for up to, for example, the A3 size. However, since the gantry 20 is formed in a gate shape when viewed from the X-axis direction, and includes a space portion 21 corresponding to the gate shape, long paper exceeding the A3 size in the X-axis direction can also be placed on the support base 41.

It should be noted that a front surface 42 is disposed at a position lowering toward the −Z direction side from the support surface 41a of the support base 41 at the −Y direction side of the main body unit 40, and a rear surface 43 is disposed at a position lowering toward the −Z direction side of the support base 41 at the +Y direction side of the main body unit 40. Then, a power button 42a, which is an example of an operation unit of the colorimetric apparatus 1, is disposed on the front surface 42.

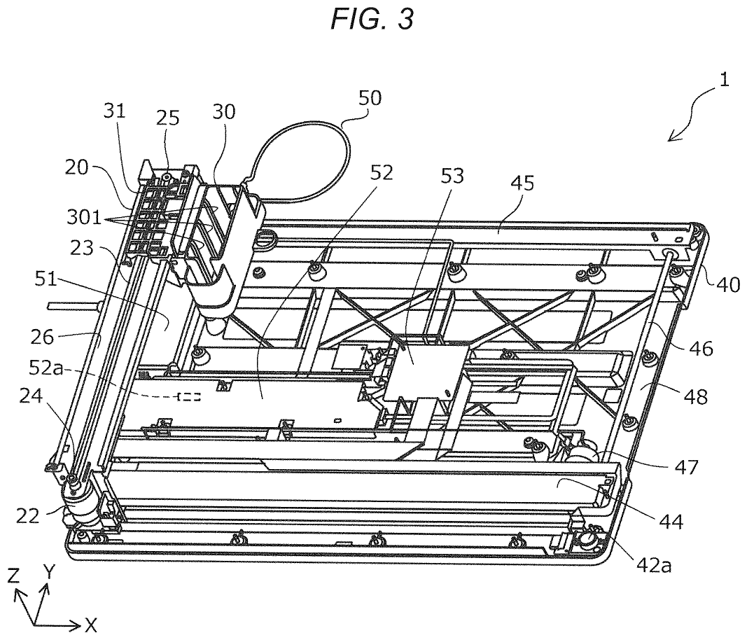

FIG. 3 is a view which shows an internal configuration of the colorimetric apparatus 1, and is a view in which exterior components shown in FIG. 2 are removed. A front frame 44 and a rear frame 45 are disposed at the +Z direction side, which is the upper side of a case lower 48, so as to extend in the X-axis direction at an interval, and a gantry frame 26 shaped like a gate, and forming a part of the gantry 20 moves along the X-axis direction along the front frame 44 and the rear frame 45.

The front frame 44 and the rear frame 45 are coupled by a coupling shaft 46 at a position at the +X direction side of the main body unit 40, and rotational drive of a gantry motor 47, which is a power source for moving the gantry 20 along the X-axis direction, is transmitted from the gantry motor 47 to the coupling shaft 46 via a gear group not shown. Then, due to the rotational drive transmitted to the coupling shaft 46, an endless belt not shown bridged between pulleys not shown disposed at the front frame 44 side, which is the −Y direction side, of the coupling shaft 46, and an endless belt not shown bridged between pulleys not shown disposed at the rear frame 45 side, which is the +Y direction side, of the coupling shaft 46 are circulated to move the gantry frame 26 coupled to these endless belts.

A carriage motor 22 is fixed to the front side corresponding to the −Y direction side of the gantry frame 26, and a carriage belt 23 shaped like an endless belt bridged between a front pulley 24 and an back pulley 25 circulates via the front pulley 24 coupled to the carriage motor 22. A carriage slider 31 constituting a part of the carriage 30 is fixed to the carriage belt 23, and moves along the Y-axis direction according to the circulation action of the carriage belt 23 with the circulation action of the carriage motor 22. It should be noted that a main board 52 as a controller and a sub-board 53, a power supply box 51, and so on are disposed inside the main body unit 40. It should be noted that the main board 52 as the controller is provided with a storage unit 52a as a nonvolatile storage capable of storing information.

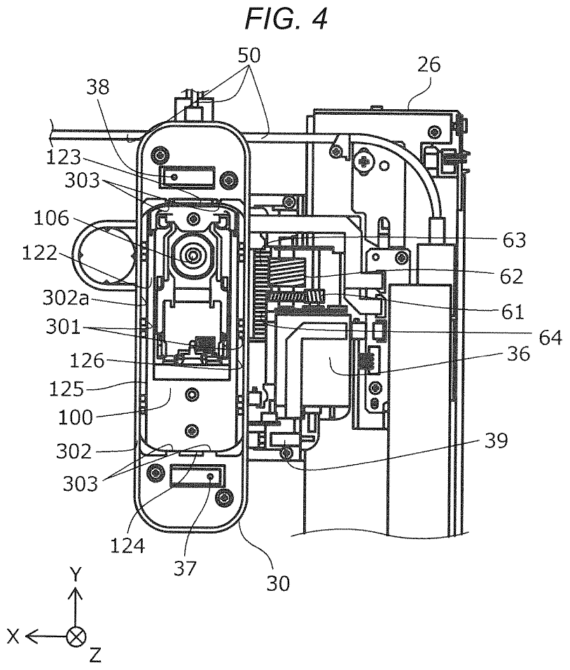

FIG. 4 is a bottom view showing the periphery of the carriage 30 in a state in which the colorimeter 100 is attached to the carriage 30. In the colorimeter 100, with respect to the carriage 30, the right side surface 125 and the left side surface 126 are supported in the Y-axis direction by ribs 301 provided to the carriage 30, and the back surface 123 and the front surface 124 are supported in the X-axis direction by ribs 303 provided to the carriage 30. It should be noted that as shown in FIG. 4, a front-side sensor 37 and a rear-side sensor 38 that are capable of detecting the width of the object to be measured are provided on a surface at the −Z direction side of the carriage 30.

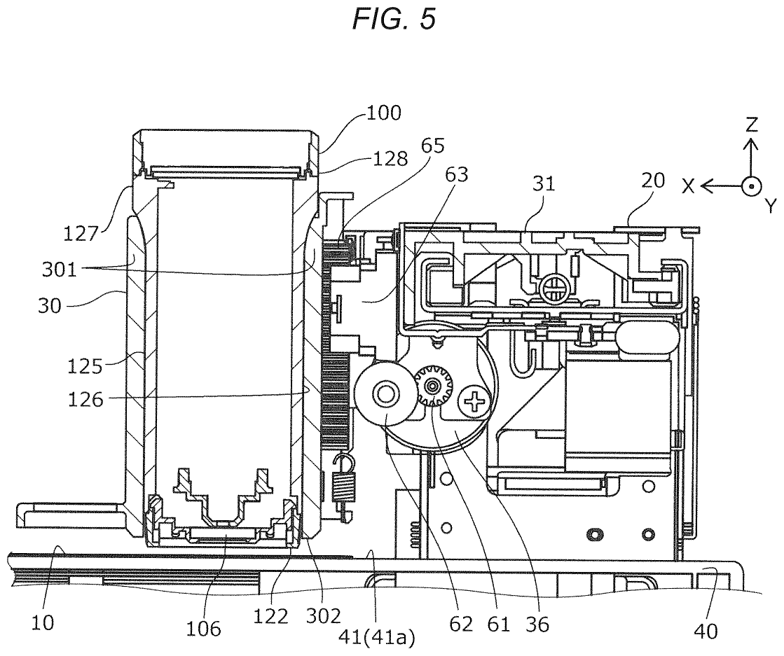

The carriage 30 slides along the Z-axis direction with respect to the gantry 20 via a rack gear 65 shown in FIG. 5 and so on by the power of a Z-axis moving direction movement motor 36 as a drive source being transmitted sequentially to a motor gear 61, a worm gear 62, a first drive gear 63, and a second drive gear 64. Further, as illustrated in FIG. 4, the carriage 30 is provided with a home position sensor 39 that detects whether the position of the carriage 30 in the Z-axis direction with respect to the gantry 20 is located at a home position.

Then, the position of the carriage 30 in the Z-axis direction with respect to the gantry 20, that is, the positions in the Z-axis direction of the carriage 30 and the colorimeter 100 housed in the carriage 30 with respect to the object to be measured placed on the support base 41 will be described with reference to FIG. 5 through FIG. 10. FIG. 5 is a diagram showing an arrangement when performing scanning with the carriage 30 in a state in which the colorimeter 100 is housed in the carriage 30, that is, when moving the carriage 30 along the Y-axis direction with respect to the gantry 20. In other words, the position of the carriage 30 in the Z-axis direction illustrated in FIG. 5 corresponds to the moving position when the carriage 30 moves in the Y-axis direction as a first direction and the X-axis direction as a third direction, and specifically corresponds to a first moving position out of moving positions. At this time, both the colorimetric surface 122 of the colorimeter 100 and a bottom surface 302 of the carriage 30 are in a state in which there is a gap in the Z-axis direction with respect to the color chart 10 which is the object to be measured. It should be noted that the first moving position shown in FIG. 5 is a default moving position in the colorimetric apparatus 1 according to the present embodiment.

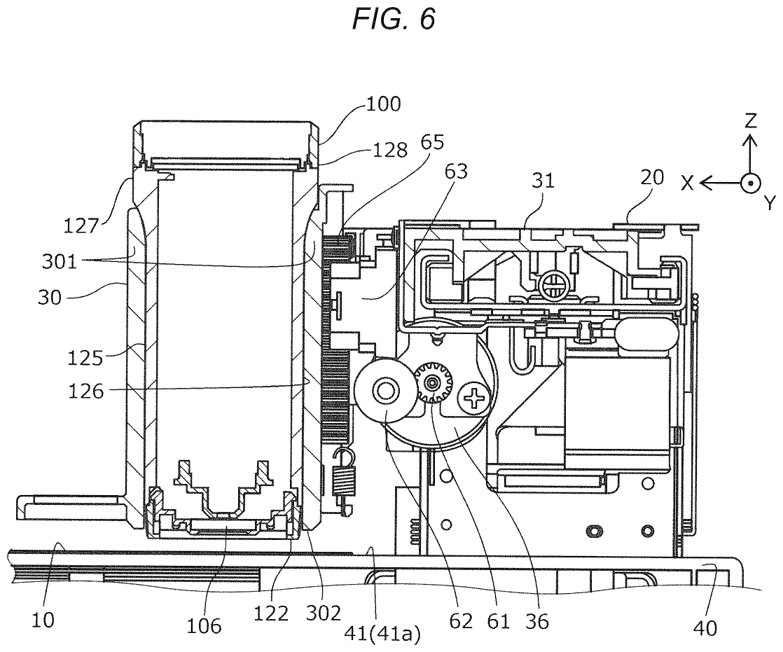

Here, in the colorimetric apparatus 1 according to the present embodiment, the second moving position shown in FIG. 6, which is located at a longer distance toward the +Z direction side from the support surface 41a of the support base 41 than the first moving position shown in FIG. 5, can be taken as the moving position in the Z-axis direction when the carriage 30 is moved in the Y-axis direction and the X-axis direction. In other words, when moving the carriage 30 in the Y-axis direction and the X-axis direction, the colorimetric apparatus 1 according to the present embodiment can move the carriage 30 at the first moving position illustrated in FIG. 5, and can move the carriage 30 at the second moving position illustrated in FIG. 6 that is longer in distance from the support surface 41a than the first moving position. As is apparent from comparison between FIG. 5 and FIG. 6, when moving the carriage 30 at the second moving position shown in FIG. 6, there is created a state in which a larger gap is formed in the Z-axis direction with respect to the color chart 10 which is the object to be measured, when compared to when moving the carriage 30 at the first moving position shown in FIG. 5. Specifically, the second moving position of the carriage 30 illustrated in FIG. 6 is a position that is 2 mm farther from the support surface 41a than the first moving position of the carriage 30 illustrated in FIG. 5. It should be noted that although FIG. 6 is an example of the second moving position, the position in the Z-axis direction of the carriage 30 when taking the second moving position can be a position closer to the support surface 41a than in the state of FIG. 6, for example, the carriage 30 is located at a position that is 1 mm farther from the support surface 41a than the first moving position illustrated in FIG. 5, or can also be a position farther from the support surface 41a than the state of FIG. 6, such as a position that is 3 mm farther from the support surface 41a than the first moving position illustrated in FIG. 5. In addition, it is possible to adopt a configuration in which it is possible to take a plurality of positions different in distance in the Z-axis direction with respect to the support surface 41a as the second moving position.

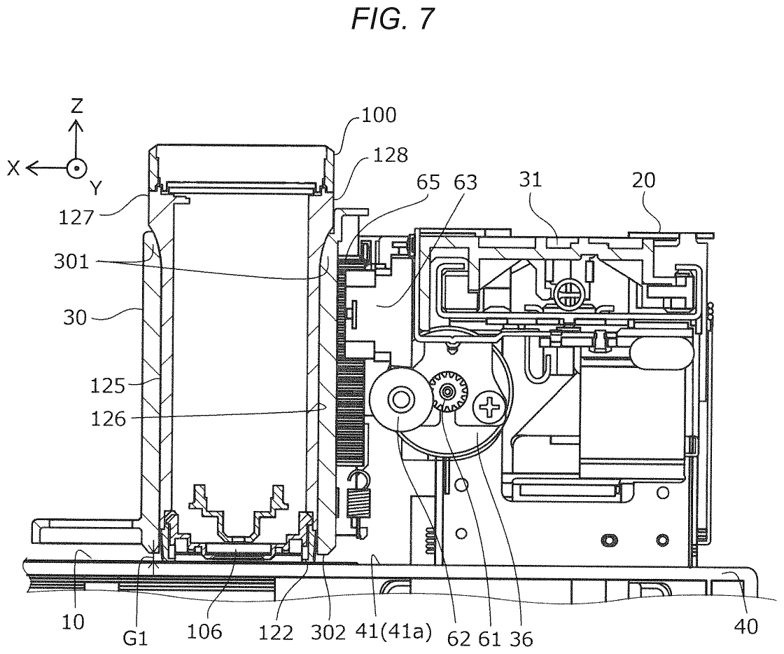

FIG. 7 is a diagram showing an arrangement at a moment when the carriage is moved in the −Z direction, which is the downward direction, from the state shown in FIG. 5 and FIG. 6, and the colorimetric surface 122 of the colorimeter 100 comes into contact with the color chart 10. It should be noted that, for example, in the present embodiment, a gap G1 in the Z-axis direction between the bottom surface 302 of the carriage 30 and the color chart 10 on this occasion is 2 mm. Here, in the present embodiment, the colorimeter 100 is housed in the carriage 30 in a state in which the convex portion 127 and the convex portion 128 are caught by and placed on the ribs 301 provided to the carriage 30 with own weight of the colorimeter 100, and the colorimetric surface 122 of the colorimeter 100 projects in the −Z direction from the hole 302a provided to the bottom surface 302 of the carriage 30 illustrated in FIG. 4.

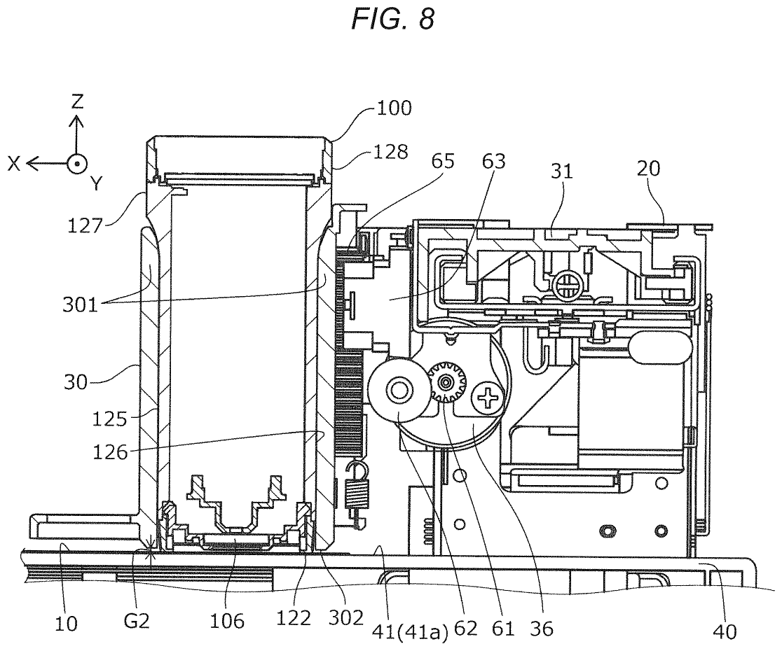

For this reason, as illustrated in FIG. 8, when the carriage 30 is further moved in the −Z direction from the state shown in FIG. 7, the own weight of the colorimeter 100 is applied to the colorimetric surface 122. It should be noted that FIG. 8 shows an arrangement when measuring the color of the colorimetric object, that is, a colorimetric position that is an arrangement when performing the colorimetry of the color patches 11 of the color chart 10 and the black frames 12. It should be noted that, for example, in the present embodiment, a gap G2 in the Z-axis direction between the bottom surface 302 of the carriage 30 and the color chart 10 is 1 mm. In other words, in the colorimetric apparatus 1 according to the present embodiment, when measuring the color of the colorimetric object, there is created a state in which the colorimetric surface 122 makes contact with the colorimetric object, but a gap is provided between the bottom surface 302 of the carriage 30 and the colorimetric object.

In the colorimetric apparatus 1 according to the present embodiment, the colorimetry is performed in a state in which the entire circumference viewed from the Z-axis direction of the colorimetric surface 122 of the colorimeter 100 makes contact with the color chart 10 on the support base 41 to conform to the surface of the color chart 10. With such a configuration, since the colorimetry can be performed in a state in which the colorimetric opening 106, which is the optical axis opening of the colorimeter 100, is covered with the colorimetric surface 122, the colorimetry is difficult to be affected by external light and thus, colorimetric accuracy is improved. It should be noted that it is possible to perform the colorimetry in a state in which the colorimetry is difficult to be affected by external light even in the state shown in FIG. 7. However, a deviation occurs in some cases in a holding position of the colorimeter 100 by the carriage 30 or the distance from the colorimetric surface 122 to the support base 41 because tolerance involved in manufacturing variations of components or the like occurs in the carriage 30, the colorimeter 100, and the support base 41. However, by further lowering the carriage 30 from the state shown in FIG. 7, it becomes possible to perform the colorimetry without being affected by such a tolerance.

Further, in the state shown in FIG. 8, the gap G2 is formed between the bottom surface 302 of the carriage 30 and the color chart 10, and there is created the state in which the bottom surface 302 of the carriage 30 and the color chart 10 are separated from each other. Therefore, there is created a state in which the weight of the carriage 30 is not applied to the color chart 10, and only the weight of the colorimeter 100 is applied to the color chart 10. Accordingly, the colorimeter 100 comes into contact with the color chart 10 in a state in which an appropriate load is applied, and therefore, the color chart 10 is difficult to be damaged.

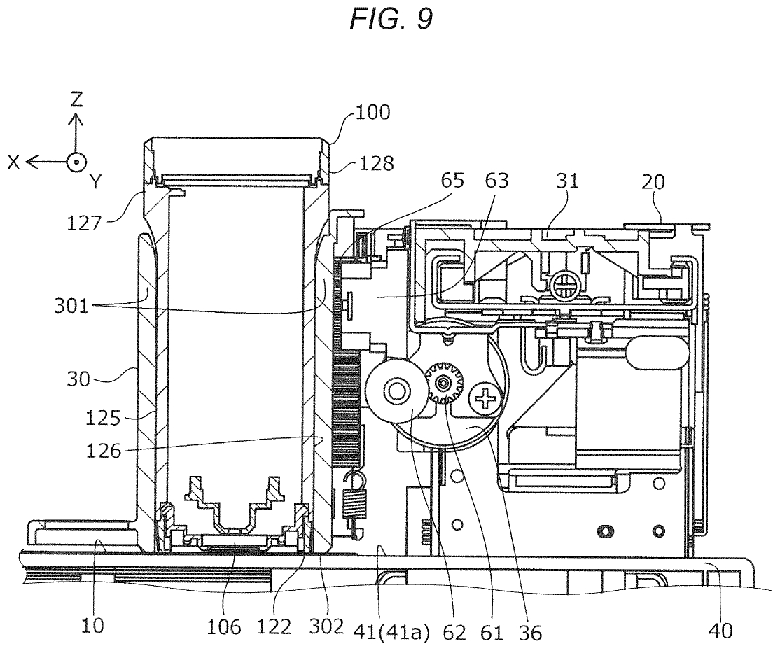

It should be noted that the colorimetric apparatus 1 according to the present embodiment is capable of measuring colors of various colorimetric objects. The colorimetric objects on which the colorimetric apparatus 1 according to the present embodiment is capable of performing the colorimetry include those having various thicknesses. For this reason, the colorimetric apparatus 1 according to the present embodiment can bring the carriage 30 into contact with the colorimetric object by moving the carriage 30 in the Z-axis direction with respect to the colorimetric object to be used to thereby measure an abutment height, which is the height of the carriage 30 when making contact therewith. In the description from another viewpoint, the abutment height of the carriage 30 means the height of the carriage 30 when the carriage 30 comes into contact with the colorimetric object. Specifically, in order to know the abutment height of the carriage 30, the colorimetric apparatus 1 according to the present embodiment can know the abutment height of the carriage 30 by driving the Z-axis moving direction movement motor 36 to continue to reduce the height of the carriage 30 until the bottom surface 302 of the carriage 30 abuts on the colorimetric object and the load of the Z-axis moving direction movement motor 36 exceeds a certain threshold value, and then detecting the height at which the load exceeds the threshold value. FIG. 9 shows a state when the bottom surface 302 of the carriage 30 abuts on the color chart 10 which is the colorimetric object, and the load of the Z-axis moving direction movement motor 36 exceeds the certain threshold value in order to know the abutment height of the carriage 30.

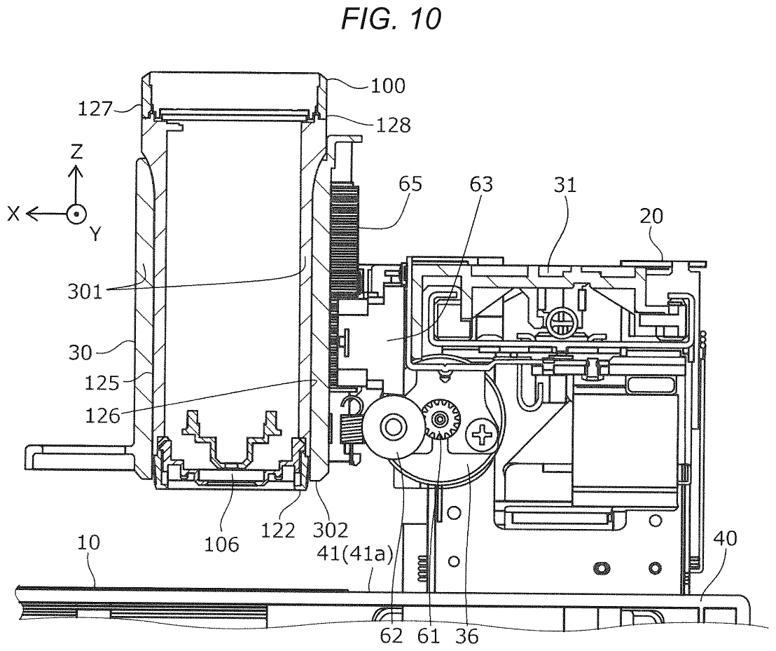

Further, as described above, the colorimetric apparatus 1 according to the present embodiment is provided with the home position sensor 39 that detects whether the position in the Z-axis direction of the carriage 30 with respect to the gantry 20 is at the home position. FIG. 10 shows a state in which the carriage 30 is at the home position in the Z-axis direction.

As described above, the colorimetric apparatus 1 according to the present embodiment includes the support base 41 that supports the color chart 10 including the color patches 11 that are a plurality of colorimetric patches with the support surface 41a, and the colorimeter 100 that measures the colors of the color chart 10 in a state of having contact with the color chart 10. The colorimetric apparatus 1 according to the present embodiment includes the carriage 30 that is movable in the Y-axis direction along the support surface 41a and the Z-axis direction opposed to the support surface 41a while supporting the colorimeter 100, and the gantry 20 that is capable of moving the carriage 30 on the support base 41 in the X-axis direction which is a direction along the support surface 41a and crossing the Y-axis direction. Further, the main board 52 as the controller capable of controlling the position in the Z-axis direction of the carriage 30, and so on are provided.

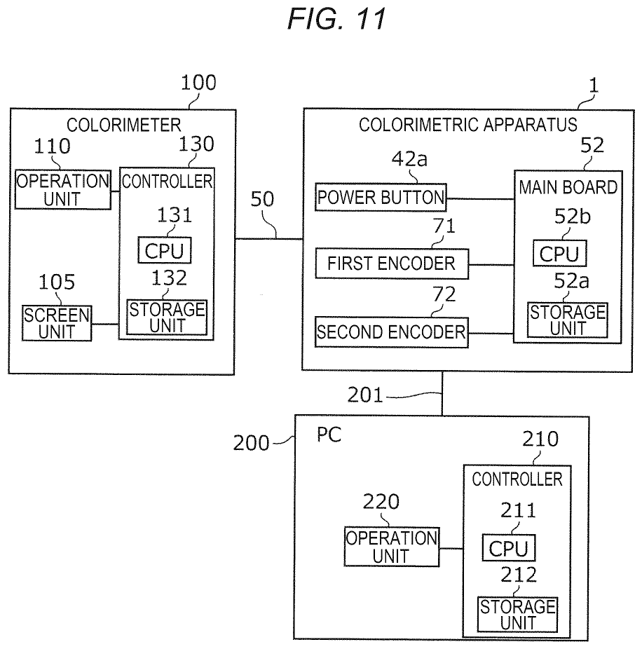

Then, an electrical configuration of the colorimetric apparatus 1 according to the present embodiment will be described with reference to FIG. 11. As shown in FIG. 11, the colorimetric apparatus 1 according to the present embodiment includes the main board 52 as the controller. It should be noted that as described above, the colorimetric apparatus 1 according to the present embodiment has a plurality of boards such as the sub-board 53 in addition to the main board 52, but the boards other than the main board 52 are omitted in FIG. 11. The main board 52 includes a CPU (Central Processing Unit) 52b and so on in addition to the storage unit 52a as a nonvolatile storage. Further, the power button 42a serving as an operation unit is electrically coupled to the main board 52. Further, the colorimetric apparatus 1 according to the present embodiment includes a first encoder 71 that measures a rotation amount by the carriage motor 22, and a second encoder 72 that measures a rotation amount by the gantry motor 47.

Further, the colorimeter 100 is coupled to the colorimetric apparatus 1 via the USB cable 50. It should be noted that in the present embodiment, the colorimetric apparatus 1 and the colorimeter 100 are electrically coupled to each other via the USB cable 50, but such a configuration is not a limitation, and the colorimetric apparatus 1 and the colorimeter 100 can electrically be coupled to each other with a wire other than the USB cable, or can also be electrically coupled wirelessly to each other with wireless communication. The colorimeter 100 includes a controller 130, and the controller 130 is provided with a CPU 131, a storage unit 132, and so on. Further, the operation unit 110 and the screen unit 105 are electrically coupled to the controller 130.

Further, a PC (Personal Computer) 200 is coupled to the colorimetric apparatus 1 via a USB cable 201. It should be noted that in the present embodiment, the colorimetric apparatus 1 and the PC 200 are electrically coupled to each other via the USB cable 201, but such a configuration is not a limitation, and the colorimetric apparatus 1 and the PC 200 can electrically be coupled to each other with a wire other than the USB cable, or can also be electrically coupled wirelessly to each other with wireless communication. The PC 200 includes a controller 210 and an operation unit 220 such as a keyboard and a mouse electrically coupled to the controller 210. Here, the controller 210 is provided with a CPU 211, a storage unit 212, and so on, and the storage unit 212 stores a plurality of applications in addition to various data and so on, and it is possible for the user to input various instructions via the operation unit 220 using the applications.

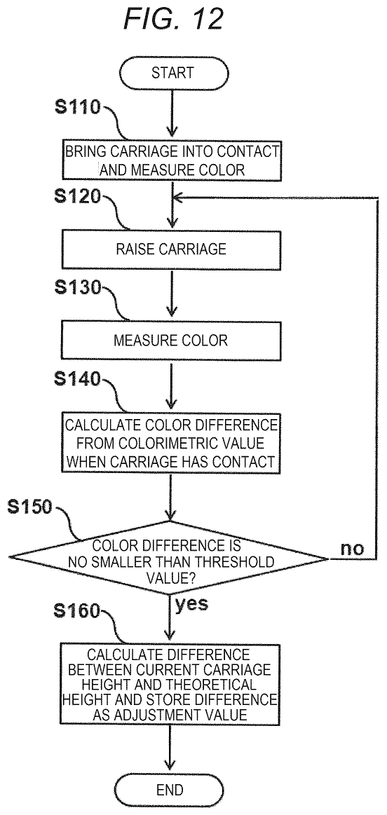

A control method to be performed using the colorimetric apparatus 1 according to the present embodiment will be described below. First, the flow when determining the setting position of the carriage 30 in the height direction represented by the flowchart in FIG. 12 will be described. It should be noted that in any of the following control methods, each step is executed based on the control by the main board 52 as the controller. When starting this flow, first, in step S110, the carriage 30 is brought into contact with a desired position of the color chart 10, and the colorimetry is performed in a state in which the carriage 30 is made to have contact with the color chart 10.

Then, in step S120, the carriage 30 is raised by a predetermined amount. In the present embodiment, the carriage is raised by, for example, 0.14 mm. Then, in step S130, the colorimetry is performed at the position where the carriage is raised by the predetermined amount.

Then, in step S140, a color difference between the colorimetric value in step S110 in which the carriage 30 is in contact with the color chart 10 and the colorimetric value in step S130 is calculated. As described above, the colorimetric apparatus 1 according to the present embodiment needs to raise the carriage 30 by approximately 2 mm from the state of FIG. 9 in which the carriage 30 is in contact with the color chart 10 to the state of FIG. 7 in which the colorimetric surface 122 starts to be separated from the color chart 10. Therefore, until the carriage 30 is raised by approximately 2 mm, the color difference calculated in step S140 is substantially zero. Then, after the carriage 30 is raised by 2 mm, the color difference increases as the carriage 30 is raised when the color difference is calculated in a state in which the carriage 30 is further raised.

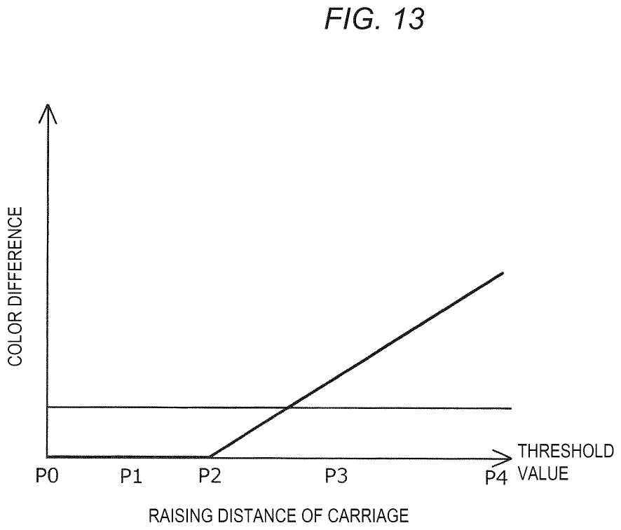

Here, FIG. 13 is a graph showing the color difference to the rising distance of the carriage 30 from the color chart 10. As shown in FIG. 13, the color difference is substantially zero while the rising distance of the carriage 30 from the color chart 10 is in a range equal to or less than a predetermined value, and the color difference thereafter increases as the carriage 30 is raised. It should be noted that in FIG. 13, the point P0 corresponds to when the carriage 30 is in the state of FIG. 9, the point P1 corresponds to when the carriage 30 is in the state of FIG. 8, the point P2 corresponds to when the carriage 30 is in the state of FIG. 7, the point P3 corresponds to when the carriage 30 is in the state of FIG. 5, and the point P4 corresponds to when the carriage 30 is in the state of FIG. 10.

Then, in step S150, whether the color difference calculated in step S140 is equal to or greater than a predetermined threshold value is determined. This determination is performed by the main board 52 as the controller. Here, when it is determined that the color difference calculated in step S140 is less than the threshold value, the process returns to step S120 to repeat the flow from step S120 to step S150. That is, the colorimetry is performed while raising the carriage 30 by 0.14 mm until the color difference calculated in step S140 becomes equal to or greater than the threshold value. On the other hand, when it is determined that the color difference calculated in step S140 is equal to or greater than the threshold value, the process proceeds to step S160.

In step S160, how much the current height of the carriage 30 with respect to the color chart 10, that is, the height of the carriage 30 with respect to the color chart 10 when the color difference is determined to be equal to or greater than the threshold value in step S150, is different compared to the theoretical height calculated in advance is calculated. Then, the calculation result is stored in the storage unit 52a, and the flow represented by the flowchart in FIG. 12 is terminated.

It should be noted that an adjustment value calculated in step S160 is used, for example, when determining the colorimetric position which is the setting position of the carriage 30 in the height direction when measuring the color of the color patch 11 or the like of the color chart 10 shown in FIG. 8, or the moving position which is the setting position of the carriage 30 in the height direction when performing scanning with the carriage 30 shown in FIG. 5 and FIG. 6. Then, for example, when continuously measuring the colors of the plurality of color patches 11 adjacent to each other provided to the color chart 10, the color of the first color patch 11 is measured at the colorimetric position shown in FIG. 8, and the color of the second color patch 11 is measured after raising the carriage 30 to the moving position shown in FIG. 5 or the moving position shown in FIG. 6, then moving the second color patch 11 adjacent to the first color patch 11 to a position where the colorimetry can be performed in the X-Y plane, and then lowering the carriage 30 to the colorimetric position shown in FIG. 8. Then, this is repeated as much as the number of the color patches 11 on which the colorimetry is performed.

Here, to describe the control method represented by the flowchart in FIG. 12 in another expression, the flow from step S120 to step S150 is repeated to move the carriage 30 in the height direction from the color chart 10 to thereby execute a colorimetric step of performing the colorimetry with the colorimetric surface 122 at a plurality of positions different in interval between the carriage 30 and the color chart 10 in the height direction. Then, as a result, by executing step S160, a calculation step of calculating the adjustment value for determining the setting position of the carriage 30 in the height direction is executed based on the colorimetric result in the colorimetric step. In the control method represented by the flowchart in FIG. 12, steps S110 through S150 obtained by adding step S110 to steps S120 through S150 correspond to the colorimetric step, and step S160 corresponds to the calculation step.

According to the above, by executing the control method represented by the flowchart in FIG. 12, it is possible to calculate the preferable setting positions of the carriage 30, such as the colorimetric positions and the moving positions, for each colorimeter 100 to be used. As a result, the height of the colorimeter 100 with respect to the color chart 10 can be prevented from being deviated from a desired height. It should be noted that it is conceivable to separately provide a sensor for detecting the height of the colorimeter 100 as a measure for setting the height of the colorimeter 100 with respect to the color chart 10 to the desired height, but it is possible to eliminate the necessity of providing such a sensor by executing the control method according to the present embodiment.

It should be noted that in the control method represented by the flowchart in FIG. 12, the colorimetry is performed while raising the colorimeter 100 stepwise by 0.14 mm in the colorimetric step. However, such a method is not a limitation. For example, it is possible to periodically perform the colorimetry while continuously raising the colorimeter 100 in the colorimetric step.

Here, in the control method represented by the flowchart in FIG. 12, the adjustment value is calculated in step S160 based on whether the color difference in step S150 is equal to or greater than the threshold value. When describing the above in another expression, in the calculation step, the height of the carriage 30 from the color chart 10 when the colorimetric value measured by the colorimeter 100 in the colorimetric step exceeds a predetermined threshold value is set as a comparison value, and the adjustment value is calculated based on a difference between the comparison value and a theoretical height which is a reference value. Here, the comparison value corresponds to the colorimetric value in step S130, and the reference value corresponds to the colorimetric value in step S110. When assuming that the setting position of the carriage 30 is determined from the height of the carriage 30 when the comparison value becomes just the same as the reference value, there is a possibility that the colorimeter 100 floats from the color chart 10 due to manufacturing tolerances of the color chart 10, the colorimeter 100, and so on. However, such a possibility can be reduced by determining the setting position of the carriage 30 based on a value obtained by correcting the comparison value. That is, it is possible to effectively suppress deviation of the height of the colorimeter 100 with respect to the color chart 10 from the desired height. It should be noted that specifically, in the present embodiment, the value obtained by lowering the colorimeter 100 by 1 mm from the comparison value that corresponds to a value when the colorimeter 100 floats from the color chart 10 is used as the value obtained by correcting the comparison value.

It should be noted that there is no particular limitation on where in the color chart 10 to execute the colorimetric step. However, in the present embodiment, the colorimetric step is performed in a state in which the colorimetric opening 106 on the colorimetric surface 122 is located at the center position of the color chart 10 when viewed from the height direction. The center position of the color chart 10 often has the average flatness of the color chart 10, and therefore, by employing such a control method, it is possible to effectively prevent the height of the colorimeter 100 with respect to the color chart 10 from deviating from the desired height. It should be noted that the “center position” as used herein means that substantially the center is only required, and it is sufficient to correspond to, for example, a central region in each of the X-axis direction and the Y-axis direction when equally dividing the color chart in each of the X-axis direction and the Y-axis direction into three equal parts.

Further, the number of times of the execution of the colorimetric step from step S110 to step S150 is not particularly limited. It should be noted that it is preferable that the colorimetric step is performed two or more times at a predetermined position in the color chart 10, and the adjustment value is calculated in the calculation step based on an average value of the colorimetric result in the colorimetric step performed two or more times. This is because an accurate adjustment value can be calculated by performing the colorimetric step two or more times, and it is possible to effectively prevent the deviation of the height of the colorimeter 100 with respect to the color chart 10 from the desired height.

In addition, it is preferable to perform the colorimetric step in at least two or more places in the color chart 10, and then calculate the adjustment value in the calculation step based on an average value of the colorimetric result in the colorimetric step performed in at least two or more places. This is because the color chart 10 is not uniform in flatness in some cases, but by adopting such a control method, it is possible to effectively prevent the height of the colorimeter 100 with respect to the color chart 10 from being deviated from the desired height.

It should be noted that the height of the carriage 30 from the color chart 10 when the colorimetric value measured by the colorimeter 100 exceeds the predetermined threshold value can be obtained in the calculation step using an approximation method. For example, when the colorimeter 100 floats from the color chart 10, the color difference in step S150 becomes substantially proportional to the height of the carriage 30 from the color chart 10. Therefore, it is possible to obtain the height of the carriage 30 from the color chart 10 at which the color difference takes the predetermined threshold value by linearly approximating the color difference obtained after the color difference exceeds the predetermined threshold value and the height of the carriage 30.

Further, the colorimetric apparatus 1 according to the present embodiment determines the colorimetric position, which is the position of the carriage 30 in the height direction when measuring the colors of the color patches 11 of the color chart 10 or the like, as the setting position of the carriage 30 based on the adjustment value calculated in step S160 which is the calculation step in the present embodiment. Therefore, it is possible to effectively prevent the deviation of the position of the carriage 30 in the height direction when measuring the color of the color chart 10 from the desired height.

Further, the colorimetric apparatus 1 according to the present embodiment is configured to be able to perform the colorimetry with the colorimeter 100 by repeating the scanning with the carriage 30 with respect to the plurality of color patches 11 provided to the color chart 10. Then, based on the adjustment value calculated in step S160 which is the calculation step in the present embodiment, the colorimetric apparatus 1 according to the present embodiment also determines the moving position, which is the position of the carriage 30 in the height direction when the colorimeter 100 is moved in the scanning with the carriage 30 from the first colorimetric position corresponding to the position of the first color patch out of the plurality of color patches 11 to the second colorimetric position corresponding to the position of the second color patch adjacent to the first color patch as the setting position of the carriage 30. Specifically, a value obtained by correcting the value obtained by adding a value with which the carriage 30 is raised by, for example, 2 mm to the adjustment value calculated in step S160 is calculated as an adjustment value when performing the scanning, and is determined as the first moving position out of the moving positions. Therefore, it is possible to effectively prevent the deviation of the position of the carriage 30 in the height direction when moving the colorimeter 100 between the plurality of patches from the desired height.

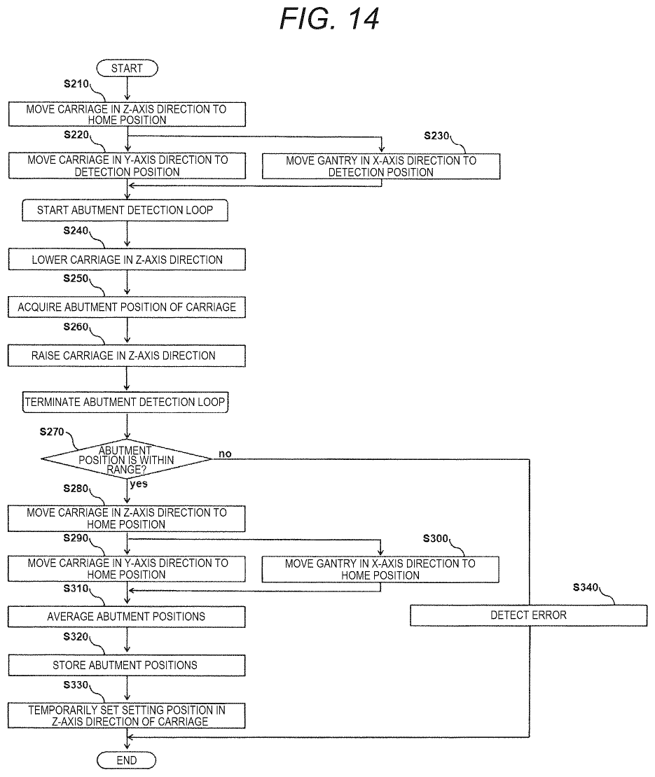

Then, a flow of measuring the thickness in the height direction of the colorimetric object before executing the flow of the flowchart in FIG. 12, which is represented by the flowchart in FIG. 14, will be described. When the flow of the flowchart in FIG. 14 is started, first, in step S210, the Z-axis moving direction movement motor 36 is driven to move the carriage 30 to the home position shown in FIG. 10. Then, subsequently, the carriage motor 22 is driven to move the carriage 30 in the Y-axis direction in step S220, and the gantry motor 47 is driven to move the gantry 20 in the X-axis direction to move the carriage 30 to the desired detection position in step S230.

Subsequently, an abutment detection loop for bringing the carriage 30 into contact with the color chart 10 plural times is performed. In the abutment detection loop, first, in step S240, the carriage 30 is lowered along the Z-axis direction which is the height direction. When the carriage 30 makes contact with the color chart 10, the position in the Z-axis direction of the carriage 30 which has made contact therewith is acquired in step S250. In the abutment detection loop, steps S240 through S260 are repeated two or more times.

Upon completion of the abutment detection loop, whether the positions in the Z-axis direction of the carriage 30 that has made contact therewith that are obtained by repeating the contact plural times are all within a predetermined range is determined in step S270. Here, when the main board 52 determines that the positions in the Z-axis direction of the carriage 30 that has made contact therewith that are obtained repeating the contact plural times are all within the predetermined range, the process proceeds to step S280. On the other hand, when the main board 52 does not determine that the positions in the Z-axis direction of the carriage 30 that has made contact therewith that are obtained by repeating the contact plural times are all within the predetermined range, an error is detected in step S340, and the flow of the flowchart in FIG. 14 is terminated.

It should be noted that in the present embodiment, such processing is performed in step S270, but instead of such processing, for example, it is possible for the process to proceed to step S280 with a result deviating from the predetermined range excluded in step S270, or to proceed to step S280 with the result deviating from the predetermined range corrected to a predetermined upper limit value and a predetermined lower limit value. In step S280, the Z-axis moving direction movement motor 36 is driven to move the carriage 30 to the home position shown in FIG. 10. Then, subsequently, the carriage motor 22 is driven to move the carriage 30 in the Y-axis direction in step S290, and the gantry motor 47 is driven to move the gantry 20 in the X-axis direction in step S300 to move the carriage 30 to the home position in the Y-axis direction, and move the gantry 20 to the home position in the X-axis direction. It should be noted that FIG. 2 and FIG. 3 illustrate a state in which the carriage 30 and the gantry 20 are at the home position in the X-Y plane.

Then, in step S310, the plurality of abutment positions detected in the abutment detection loop is averaged, and in step S320, the abutment position thus averaged is stored in the storage unit 52a. Then, further, the setting position of the carriage 30 in the Z-axis direction is temporarily set with reference to the abutment position thus averaged in step S330, and then the flow of the flowchart in FIG. 14 is terminated. It should be noted that the setting position of the carriage 30 set temporarily is corrected and then set by executing the flow of the flowchart in FIG. 12.

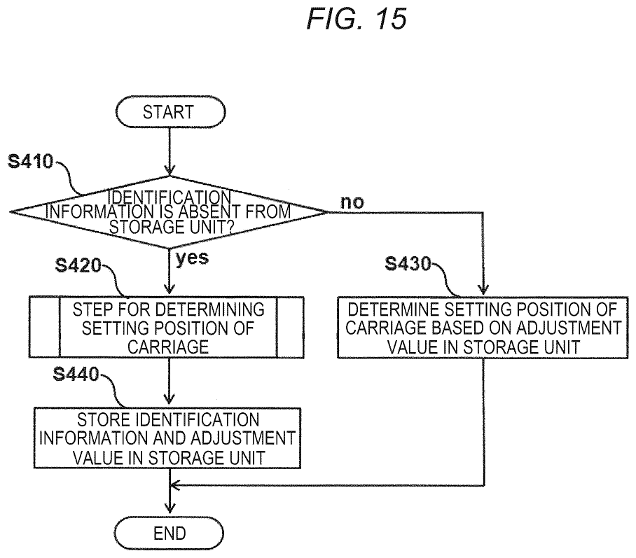

Then, a flow when the colorimeter 100 to be used is changed represented by the flowchart in FIG. 15 will be described. As described above, in the colorimetric apparatus 1 according to the present embodiment, the colorimeter 100 is detachably attached to the carriage, and a plurality of types of the colorimeters 100 can be used. It should be noted that the colorimeters 100 that can be used in the colorimetric apparatus 1 according to the present embodiment each have identification information. Further, the storage unit 52a of the colorimetric apparatus 1 according to the present embodiment is capable of storing the identification information corresponding to each of the colorimeters 100.

When the new colorimeter 100 is attached to the carriage 30 and the flow of the flowchart in FIG. 15 is started, first, in step S410, the main board 52 determines whether the identification information of the colorimeter 100 that has newly been attached is stored in the storage unit 52a. Then, when it is determined that the identification information of the colorimeter 100 that has newly been attached is not stored in the storage unit 52a, the process proceeds to step S420, and when it is determined that the identification information of the colorimeter 100 that has newly been attached is stored in the storage unit 52a, the process proceeds to step S430. Here, step S420 is the control method itself represented by the flowchart in FIG. 12.

When the process proceeds to step S430, since the adjustment value of the colorimeter 100 that has newly been attached has already been stored in the storage unit 52a, the setting position of the carriage 30 in the height direction is determined based on this adjustment value. On the other hand, when the process proceeds to step S420, the setting position of the carriage 30 in the height direction is determined based on the adjustment value in step S160 of the flowchart in FIG. 12 obtained by executing step S420. It should be noted that after the completion of step S420, the identification information and the adjustment value of the new colorimeter 100 are stored in the storage unit 52a. Then, the flow of the flowchart in FIG. 15 is terminated in accordance with the termination of step S440 or the termination of step S430.

When describing the flow of the flowchart in FIG. 15 in another expression, the identification information of the colorimeter 100 that has newly been attached is acquired in step S410. That is, step S410 can be expressed as an acquisition step of acquiring first identification information out of the identification information provided to the first colorimeter supported by the carriage 30 out of the colorimeters 100. Further, step S410 can also be expressed as a determination step of determining whether the first identification information matches the identification information stored in the storage unit 52a. Further, as described above, when it is determined in the determination step that the first identification information does not match the identification information stored in the storage unit 52a, a storing step of storing the first identification information acquired in the acquisition step into the storage unit 52a is performed in step S440, and the calculation step in step S160 provided to step S420 is performed.

By executing such a control method, it is possible to determine whether to perform the calculation step for each of the colorimeters 100 that are newly used. Therefore, even when the colorimeter 100 that has not been used so far is attached, the height of the colorimeter 100 with respect to the color chart 10 can be prevented from being deviated from the desired height.

In the flow of the flowchart in FIG. 15, when it is determined in step S410 that the process proceeds to step S430, in other words, when it is determined in the determination step that the first identification information matches the identification information stored in the storage unit 52a, the storing process in step S440 and the calculation step in step S160 provided to step S420 are not performed. By adopting such a control method, it is possible to omit the flow of determining the setting position of the carriage 30 shown in FIG. 12 when the colorimeter 100 that has been used so far is attached. Accordingly, it is possible to shorten the time required for the flow of determining the setting position of the carriage 30.

However, adopting such a flow is not a limitation. Even when it has been determined in step S410 that the identification information of the colorimeter 100 attached to the carriage 30 matches the identification information stored in the storage unit 52a, it is possible for the process to proceed to step S420 to perform the calculation step in step S160. This is because, there is a possibility that the preferred setting position of the carriage 30 in the height direction deviates, for example, after a predetermined time has elapsed or after the colorimetric apparatus 1 is transported.

Here, as described above, the carriage 30 in the present embodiment is movable in the Z-axis direction to the colorimetric position and the moving position, and is also movable in the Z-axis direction to the first moving position which is shown in FIG. 5, and corresponds to a default state, and the second moving position which is shown in FIG. 6, and is longer in distance with respect to the support surface 41a than the first moving position as the moving positions under the control by the main board 52. Further, the colorimetric apparatus 1 according to the present embodiment is capable of performing a colorimetric operation setting the moving position to the first moving position or the second moving position. Therefore, when the color chart 10 has unevenness and there is a possibility that the color chart 10 and the colorimeter 100 rub against each other or the color chart 10 and the carriage 30 rub against each other, by setting the moving position to the second moving position instead of the first moving position, it becomes possible to prevent the color chart 10 and the colorimeter 100 from rubbing against each other or the color chart 10 and the carriage 30 from rubbing against each other. As a result, the colorimetric apparatus 1 according to the present embodiment is capable of preventing the color chart 10 from being damaged and the colorimeter 100 and the carriage 30 from being damaged.

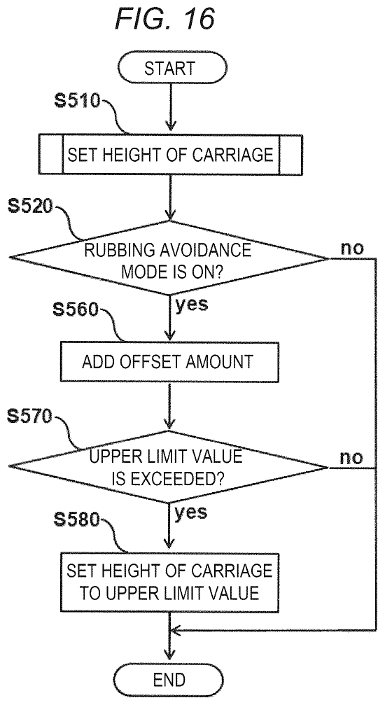

Therefore, a colorimetric method according to Practical Example 1 that is performed using the colorimetric apparatus 1 according to the present embodiment, and that is a method of performing the colorimetric operation while preventing the color chart 10 and the colorimeter 100 from rubbing against each other and the color chart 10 and the carriage 30 from rubbing against each other, will hereinafter be described with reference to a flowchart in FIG. 16. When the colorimetric method represented by the flowchart in FIG. 16 is started, first, the height of the carriage 30 is set in step S510. This corresponds to the flow of the flowchart in FIG. 12.

Then, in step S520, the main board 52 determines whether a rubbing avoidance mode is selected by the user via the operation unit 220 of the PC 200. The colorimetric apparatus 1 according to the present embodiment is capable of starting up an application stored in the storage unit 212 of the PC 200 to select whether to execute the rubbing avoidance mode using the operation unit 220. When the rubbing avoidance mode has been selected by the user, the main board 52 proceeds to step S560, and when the rubbing avoidance mode has not been selected by the user, the main board 52 ends the colorimetric method represented by the flowchart in FIG. 16, and performs the colorimetric operation in a state of keeping the setting of the moving position to the first moving position as a default position.

In step S560, the moving position is reset from the first moving position to the second moving position by adding a desired offset amount to the first moving position. It should be noted that the offset amount corresponds to a length to be added to the first moving position in a direction in which the carriage 30 is made to get away from the support surface 41a. Further, it is possible to adopt a configuration in which the user inputs a certain length as the offset amount via the operation unit 220 of the PC 200, or it is also possible to adopt a configuration in which the user selects the offset amount from a plurality of lengths stored in, for example, the storage unit 52a via the operation unit 220 of the PC 200.

Then, in step S570, the main board 52 determines whether the second moving position exceeds the upper limit value of the movement range in the +Z direction of the carriage 30 by adding the desired offset amount to the first moving position. When it is determined that the second moving position exceeds the upper limit value of the movement range in the +Z direction of the carriage 30, the process proceeds to step S580. On the other hand, when it is determined that the second moving position does not exceed the upper limit value of the movement range in the +Z direction of the carriage 30, the colorimetric method represented by the flowchart in FIG. 16 is terminated keeping the state in which the moving position is set to the second moving position obtained by adding the offset amount to the first moving position in step S560, and the colorimetric operation is performed in the state in which the moving position is set to the second moving position.

In step S580, the moving position is set to the second moving position, and the second moving position set at that time is set to the upper limit value of the movement range in the +Z direction of the carriage 30. Then, the colorimetric method represented by the flowchart in FIG. 16 is terminated, and then the colorimetric operation is performed in the state in which the moving position is set to the upper limit value of the movement range in the +Z direction of the carriage 30.

Here, the colorimetric apparatus 1 according to the present embodiment includes the storage unit 52a, and the offset amount related to the moving position in step S560 is stored in the storage unit 52a. Further, as described above, the second moving position is a position obtained by adding the offset amount to the first moving position in the +Z direction that is a separating direction of getting away from the support surface 41a. In this way, it is possible to omit the time and effort for the user to set the offset amount. It should be noted that the colorimetric apparatus 1 according to the present embodiment is capable of storing a certain offset amount in the storage unit 52a via the operation unit 220 of the PC 200 or the like.

In addition, as described in the explanation of step S520 and step S560, the main board 52 is capable of receiving input of the offset amount by the user with respect to the moving position via the operation unit 220 of the PC 200. Further, it is possible to set the second moving position as a position obtained by adding the offset amount input by the user to the first moving position in the +Z direction. Therefore, the user can suitably set the offset amount according to the level of the unevenness of the color chart 10 and so on. It should be noted that as described above, it is possible to adopt a configuration in which a specific length is input as the offset amount, but it is also possible to adopt a configuration of selecting lengths set in advance.

In addition, as described in the explanation of step S580, when the position obtained by adding the offset amount to the first moving position in the +Z direction exceeds the upper limit value which is a limit position of the movable range in the +Z direction of the carriage 30, the main board 52 sets the second moving position as the upper limit value. Therefore, the colorimetric apparatus 1 according to the present embodiment is capable of preventing a situation in which the moving position is set beyond the limit position of the movable range in the +Z direction of the carriage 30 to cause damage in the apparatus.

Further, as described in the explanation of step S520, the main board 52 is capable of receiving the selection of the rubbing avoidance mode which is an instruction to change the moving position from the first moving position to the second moving position, and change the moving position from the first moving position to the second moving position in response to receiving the instruction. Therefore, when the user assumes that there is a possibility that the color chart 10 and the colorimeter 100 rub against each other or a possibility that the color chart 10 and the carriage 30 rub against each other, it is possible for the user to change the moving position from the first moving position to the second moving position in accordance with the user's intention. It should be noted that in the colorimetric apparatus 1 according to the present embodiment, there is adopted the configuration in which the main board 52 is capable of receiving the instruction from the PC 200 as external equipment, but it is possible to adopt a configuration in which an operation panel or the like is provided to the colorimetric apparatus 1, and an instruction by the user is received from a constituent member provided to the colorimetric apparatus 1 such as the operation panel.

It should be noted that as shown in FIG. 2, the color chart 10 is provided with the black frame 12 as a detection target portion for detecting a position when supported by the support surface 41a. Further, as shown in FIG. 4, the carriage 30 includes the front-side sensor 37 and the rear-side sensor 38, which are a detection unit for detecting the black frame 12. Under the control by the main board 52, the carriage 30 is capable of setting the moving position when detecting the black frame 12 to the second moving position in response to the reception of the selection of the rubbing avoidance mode. Since the colorimetric apparatus 1 according to the present embodiment has such a configuration, even when detecting the black frame 12, it is possible to prevent the color chart 10 from being damaged and the colorimeter 100 and the carriage 30 from being damaged.

Further, the colorimetric apparatus 1 according to the present embodiment is provided with the carriage motor 22 that is a first motor as a drive source for moving the carriage 30 in the Y-axis direction, and the gantry motor 47 that is a second motor as a drive source for moving the carriage 30 in the X-axis direction. Further, the colorimetric apparatus 1 according to the present embodiment is configured to be able to announce at least one of the fact that the load of the carriage motor 22 exceeds a first load and the fact that the load of the gantry motor 47 exceeds a second load on a display of the PC 200 and so on. Here, when the color chart 10 and one of the colorimeter 100 and the carriage 30 rub against each other, the load of the carriage motor 22 or the gantry motor 47 increases. Therefore, when there is a high possibility that the color chart 10 and one of the colorimeter 100 and the carriage 30 rub against each other, the user can figure out this possibility, and can thereafter prevent such rubbing by changing the moving position from the first moving position to the second moving position.

Further, the colorimetric apparatus 1 according to the present embodiment includes a first encoder 71 that measures a rotation amount by the carriage motor 22, and a second encoder 72 that measures a rotation amount by the gantry motor 47. Further, there is adopted the configuration in which at least one of the fact that an amount of change in the rotation amount of the first encoder 71 becomes equal to or less than a first threshold value, and the fact that an amount of change in the rotation amount of the second encoder 72 becomes equal to or less than a second threshold value can be announced on the display of the PC 200. Here, when the color chart 10 and one of the colorimeter 100 and the carriage 30 rub against each other, the amount of change in the rotation amount detected by the encoder for measuring the rotation amount of the motor decreases. Therefore, when there is a high possibility that the color chart 10 and one of the colorimeter 100 and the carriage 30 rub against each other, the user can figure out this possibility, and can thereafter prevent such rubbing by changing the moving position from the first moving position to the second moving position.

Further, the colorimetric apparatus 1 according to the present embodiment is configured so as to be able to announce at least one of the fact that the moving speed of the carriage 30 based on the rotation amount of the first encoder 71 becomes equal to or less than a third threshold value, and the fact that the moving speed of the carriage 30 based on the rotation amount of the second encoder 72 becomes equal to or less than a fourth threshold value on the display of the PC 200. Here, when the color chart 10 and one of the colorimeter 100 and the carriage 30 rub against each other, the moving speed of the carriage 30 based on the rotation amount of the motor becomes slower. Therefore, when there is a high possibility that the color chart 10 and one of the colorimeter 100 and the carriage 30 rub against each other, the user can figure out this possibility, and can thereafter prevent such rubbing by changing the moving position from the first moving position to the second moving position.

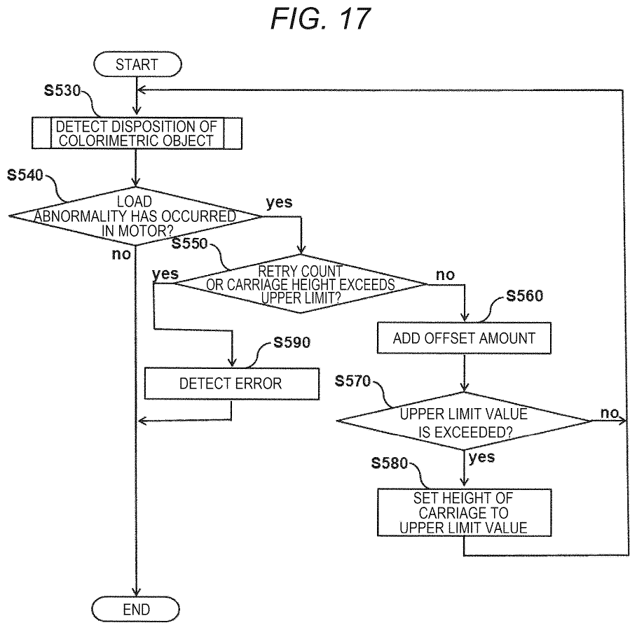

Then, a colorimetric method according to Practical Example 2 that is performed using the colorimetric apparatus 1 according to the present embodiment, and that is a method of performing the colorimetric operation while preventing the color chart 10 and the colorimeter 100 from rubbing against each other and the color chart 10 and the carriage 30 from rubbing against each other, will be described with reference to a flowchart in FIG. 17. When the colorimetric method represented by the flowchart in FIG. 17 is started, first, in step S530, an arrangement detection of the color chart 10 as the colorimetric object is performed. The arrangement detection of the color chart 10 is performed by detecting four black frames 12 provided to the color chart 10 with the front-side sensor 37 and the rear-side sensor 38. It is possible to grasp an arrangement of the color chart 10 on the support surface 41a and an inclination of the color chart 10 with respect to the support base 41 viewed from the Z-axis direction based on detection positions of the four black frames 12.

Then, in step S540, the main board 52 determines whether at least one of the fact that the load of the carriage motor 22 exceeds the first load, and the fact that the load of the gantry motor 47 exceeds the second load has occurred when executing step S530. When the main board 52 has determined that at least one of the fact that the load of the carriage motor 22 exceeds the first load, and the fact that the load of the gantry motor 47 exceeds the second load has occurred, the process proceeds to step S550. On the other hand, when the main board 52 has determined that neither the fact that the load of the carriage motor 22 exceeds the first load nor the fact that the load of the gantry motor 47 exceeds the second load has occurred, the colorimetric method represented by the flowchart in FIG. 17 is terminated, and the colorimetric operation is performed without changing the moving position.

In step S550, the main board 52 determines whether the number of retry times of changing the setting of the moving position has exceeded an upper limit, and determines whether the moving position has exceeded the upper limit value of the movement range in the +Z direction of the carriage 30 by adding the desired offset amount. When the main board 52 has determined that either of these facts is true, error detection is performed in step S590, and the colorimetric method represented by the flowchart in FIG. 17 is terminated. On the other hand, when the main board 52 has determined that neither of these facts is true, the process proceeds to step S560, step S570, and step S580. It should be noted that step S560 through step S580 are substantially the same as the steps of the flowchart in FIG. 16, and the process returns to step S530 after the completion of step S580.

Further, as described in the explanation of step S540, the main board 52 is configured to be able to input the loads of the carriage motor 22 and gantry motor 47, which are movement information related to at least one of the Y-axis direction and X-axis direction of the carriage, and is capable of determining whether to change the moving position, that is, whether to set the moving position to the first moving position or the second moving position, based on the movement information. Therefore, when there is a possibility that the color chart 10 and one of the colorimeter 100 and the carriage 30 rub against each other, the colorimetric apparatus 1 according to the present embodiment can automatically change the moving position from the first moving position to the second moving position.

Specifically, when at least one of the fact that the load of the carriage motor 22 as the movement information exceeds the first load, and the fact that the load of the gantry motor 47 as the movement information exceeds the second load is true, the main board 52 can determine the second moving position as the moving position. That is, when there is a high possibility that the color chart 10 and one of the colorimeter 100 and the carriage 30 rub against each other, the colorimetric apparatus 1 according to the present embodiment can automatically change the moving position from the first moving position to the second moving position, and can thereafter prevent such rubbing.

It should be noted that it is also possible for the colorimetric apparatus 1 according to the present embodiment to make the main board 52 perform the step of determining the moving position to the second moving position when at least one of the fact that the amount of change in the rotation amount of the first encoder 71 as the movement information becomes equal to or less than the first threshold value, and the fact that the amount of change in the rotation amount of the second encoder 72 as the movement information becomes equal to or less than the second threshold value is true, instead of step S540. Even when such a process is adopted, when there is a high possibility that the color chart 10 and one of the colorimeter 100 and the carriage 30 rub against each other, it is possible to automatically change the moving position from the first moving position to the second moving position, and it is possible to thereafter prevent such rubbing.

Further, it is also possible for the colorimetric apparatus 1 according to the present embodiment to make the main board 52 perform the step of determining the moving position to the second moving position when at least one of the fact that the moving speed of the carriage 30 based on the rotation amount of the first encoder 71 as the movement information becomes equal to or less than the third threshold value, and the fact that the moving speed of the carriage based on the rotation amount of the second encoder 72 as the movement information becomes equal to or less than the fourth threshold value is true, instead of step S540. Even when such a process is adopted, when there is a high possibility that the color chart 10 and one of the colorimeter 100 and the carriage 30 rub against each other, it is possible to automatically change the moving position from the first moving position to the second moving position, and it is possible to thereafter prevent such rubbing.

The present disclosure is not limited to the embodiment described above and can be implemented in various configurations without departing from the gist of the present disclosure. For example, the colorimetric apparatus 1 according to the present embodiment is configured to measure the color of the colorimetric object in the state in which the colorimetric apparatus 1 is in contact with the colorimetric object, but may be applied to a configuration in which the colorimetric apparatus 1 measures the color of the colorimetric object in a state in which the colorimetric apparatus 1 is not in contact with the colorimetric object. For example, the technical features in the embodiment corresponding to the technical features in the aspects described in the summary can be substituted or combined as appropriate in order to solve a part or all of the problems described above or in order to achieve a part or all of the advantages described above. Further, unless the technical features are described as essential technical features in the specification, the technical features can be deleted as appropriate.

What is claimed is:

1. A colorimetric apparatus configured to be attached with a colorimeter configured to measure a color of a colorimetric object including a plurality of colorimetric patches in a state of having contact with the colorimetric object, the colorimetric apparatus comprising:
a support base configured to support a colorimetric object including a plurality of colorimetric patches with a support surface;
a carriage configured to support the colorimeter, and configured to move in a first direction along the support surface and a second direction crossing the support surface;
a movement mechanism unit configured to move the carriage on the support base in a third direction along the support surface and crossing the first direction; and
a controller configured to control a position in the second direction of the carriage, wherein
the controller is configured to
move the carriage in the second direction to a colorimetric position when measuring the color of the colorimetric patch and a moving position when the carriage moves in the first direction and the third direction, and
move the carriage in the second direction to a first moving position and a second moving position longer in distance with respect to the support surface than the first moving position as the moving position, and
a colorimetric operation is executed setting the moving position to the first moving position or the second moving position.

2. The colorimetric apparatus according to claim 1, further comprising:
a storage unit configured to store an offset amount related to the moving position, wherein
the second moving position is a position obtained by adding the offset amount to the first moving position in a separating direction of getting away from the support surface.

3. The colorimetric apparatus according to claim 1, wherein
the controller is configured to receive input of an offset amount related to the moving position, and
the second moving position is a position obtained by adding the offset amount to the first moving position in a separating direction of getting away from the support surface.

4. The colorimetric apparatus according to claim 2, wherein
when the position obtained by adding the offset amount to the first moving position in the separating direction exceeds a limit position of a movable range in the separating direction of the carriage, the controller sets the limit position as the second moving position.

5. The colorimetric apparatus according to claim 1, wherein
the controller is configured to receive an instruction to change the moving position from the first moving position to the second moving position, and is configured to change the moving position from the first moving position to the second moving position in response to receiving the instruction.

6. The colorimetric apparatus according to claim 5, wherein
the colorimetric object is provided with a detection target portion to be used to detect a position when the colorimetric object is supported by the support surface, and
the carriage includes a detection unit configured to detect the detection target portion, and is configured to set the moving position when detecting the detection target portion to the second moving position in response to receiving the instruction under control by the controller.

7. The colorimetric apparatus according to claim 5, further comprising:
a first motor as a drive source of movement in the first direction of the carriage; and
a second motor as a drive source of movement in the third direction of the carriage, wherein
the controller is configured to announce at least one of exceedance of a load of the first motor over a first load and exceedance of a load of the second motor over a second load.

8. The colorimetric apparatus according to claim 5, further comprising:
a first motor as a drive source of movement in the first direction of the carriage;
a first encoder configured to measure a rotation amount by the first motor;
a second motor as a drive source of movement in the third direction of the carriage; and
a second encoder configured to measure a rotation amount by the second motor, wherein
the controller is configured to announce at least one of a change in variation of the rotation amount of the first encoder to a level equal to or less than a first threshold value and a change in variation of the rotation amount of the second encoder to a level equal to or less than a second threshold value.

9. The colorimetric apparatus according to claim 5, further comprising:
a first motor as a drive source of movement in the first direction of the carriage;
a first encoder configured to measure a rotation amount by the first motor;
a second motor as a drive source of movement in the third direction of the carriage; and
a second encoder configured to measure a rotation amount by the second motor, wherein
the controller is configured to announce at least one of a change in moving speed of the carriage based on the rotation amount of the first encoder to a level equal to or less than a third threshold value and a change in moving speed of the carriage based on the rotation amount of the second encoder to a level equal to or less than a fourth threshold value.

10. The colorimetric apparatus according to claim 1, wherein
the controller is configured to accept movement information related to at least one of the first direction and the third direction of the carriage, and is configured to determine whether to set the moving position to the first moving position or to set the moving position to the second moving position based on the movement information.

11. The colorimetric apparatus according to claim 10, further comprising:
a first motor as a drive source of movement in the first direction of the carriage; and
a second motor as a drive source of movement in the third direction of the carriage, wherein
the controller is configured to determine the second moving position as the moving position when at least one of exceedance of a load of the first motor as the movement information over a first load and exceedance of a load of the second motor as the movement information over a second load is true.

12. The colorimetric apparatus according to claim 10, further comprising:
a first motor as a drive source of movement in the first direction of the carriage;
a first encoder configured to measure a rotation amount by the first motor;
a second motor as a drive source of movement in the third direction of the carriage; and
a second encoder configured to measure a rotation amount by the second motor, wherein
the controller is configured to determine the second moving position as the moving position when at least one of a change in variation of the rotation amount of the first encoder as the movement information to a level equal to or less than a first threshold value and a change in variation of the rotation amount of the second encoder as the movement information to a level equal to or less than a second threshold value is true.

13. The colorimetric apparatus according to claim 10, further comprising:
a first motor as a drive source of movement in the first direction of the carriage;
a first encoder configured to measure a rotation amount by the first motor;
a second motor as a drive source of movement in the third direction of the carriage; and
a second encoder configured to measure a rotation amount by the second motor, wherein
the controller is configured to determine the second moving position as the moving position when at least one of a change in moving speed of the carriage based on the rotation amount of the first encoder as the movement information to a level equal to or less than a third threshold value and a change in moving speed of the carriage based on the rotation amount of the second encoder as the movement information to a level equal to or less than a fourth threshold value is true.

14. A colorimetric method of a colorimetric apparatus including
a support base configured to support a colorimetric object including a plurality of colorimetric patches with a support surface,
a colorimeter configured to measure a color of the colorimetric object in a state of having contact with the colorimetric object,
a carriage configured to support the colorimeter, and configured to move in a first direction along the support surface and a second direction crossing the support surface, and
a movement mechanism unit configured to move the carriage on the support base in a third direction along the support surface and crossing the first direction, wherein
the carriage is configured to
move in the second direction to a colorimetric position when measuring the color of the colorimetric patch and a moving position when the carriage moves in the first direction and the third direction, and
move in the second direction to a first moving position and a second moving position longer in distance with respect to the support surface than the first moving position as the moving position, the method comprising:
executing a colorimetric operation setting the moving position to the first moving position or the second moving position in accordance with a state of the colorimetric object.
